(19) United States
(12) Patent Application Publication
(10) Pub. No.: US 2015/0201437 A1
(43) Pub. Date: Jul. 16, 2015

(54) SYSTEMS AND METHODS FOR REDUCING SIGNALING IN AN INTERNET PROTOCOL TELEPHONY SYSTEM

(71) Applicant: Vonage Network, LLC, Holmdel, NJ (US)

(72) Inventors: MARK WOOTTON, WALL, NJ (US); ARTHUR WILTON, EAST WINDSOR, NJ (US)

(73) Assignee: VONAGE NETWORK, LLC, Holmdel, NJ (US)

(21) Appl. No.: 14/153,253

(22) Filed: Jan. 13, 2014

(51) Int. Cl. H04W 76/02; H04L 29/06

(52) U.S. Cl. CPC H04W 76/02; H04L 65/1069; H04L 65/1006; H04L 65/1026; H04W 88/16

(57) ABSTRACT

A user telephony device or an IP telephony software application on a user telephony device is capable of setting up a new telephony communication via an IP telephony system under any one of multiple service plans. The telephony device or IP telephony software application selects one of the service plans, possibly with user input, and records information about the selected service plan in a telephony communication setup request that is sent to the IP telephony system.

### BACKGROUND OF THE INVENTION

The invention is related to telephony communications systems. More specifically, the invention is related to methods performed by an IP telephony system and a user's IP telephony device or IP telephony software to setup new telephony communications.

Voice over Internet protocol telephony service providers are now offering telephony services to users in a variety of different ways. In addition to providing a user with basic telephony service for a home or office, IP telephony service providers are now providing users with service via desktop computers, mobile computing devices, cellular telephones and smart phones. Virtually any computing device that can obtain access to the Internet can now be used to conduct IP based telephone calls via an IP telephony service provider.

In a typical situation, when a user wishes to obtain telephony services from an IP telephony service provider, the user downloads a software application provided by the IP telephony service provider onto a computing device or a smart phone. The user then signs up for or purchases a particular bundle of telephony services. A single IP telephony service provider typically offers a variety of different service plans, each of which provides a user with a different bundle of services. Also, the rates that are charged may vary from plan to plan, even for the same basic services. A user typically selects the service plan which offers the lowest rates for the types of telephony services the user expects to use.

In some instances, a user may pre-pay for telephony services, and the cost of any telephony services that are provided to the user are deduced from the amount that the user pre-paid. In other instances, the user may pay a monthly fixed fee for unlimited calls, or a fixed maximum number of calling minutes for calls to certain locations. In still other instances, a user may select a rate plan that results in the user being charged various per-minute rates for calls to various locations, and the user may be billed monthly for such calls. Of course, a variety of other charging and billing arrangements are also possible.

The IP telephony software application that a user loads onto a computing device or smart phone is typically provided with an identification number. When the user runs the software application to obtain telephony services, the software application contacts an element of an IP telephony system and registers with the system. The identification number of the user's IP telephony software application is used to identity the user, and it may also be used by the IP telephony system to determine which service plan the user selected. This, in turn, determines what telephony services the IP telephony system will provide to the user, and the rates that the user is charged for any telephony services that are provided.

The IP telephony software application that a user loads onto a computing device or smart phone, and that a user runs to obtain telephony services, is typically only tied to a single service plan. However, it is common for a user to register with the same IP telephony service provider for multiple service plans. For example, a user may register for a first service plan that provides unlimited calls within a home country for a fixed monthly fee, and a second service plan that provides relatively low per-minute charges for calls to certain foreign countries. However, in order to sign up for both service plans, the user must download and install two software applications from the IP telephony service provider, one for each service plan. The user must also run and use the correct software application when placing calls. In other words, the user must be sure to run and use only the software application that is for home country calls when placing a call to a home country telephone number, and the user must be sure to run and use only the foreign calling application when placing calls to a foreign country. For these reasons, it can be somewhat inconvenient to the user. This arrangement also likely will result in the user receiving two separate monthly bills from the IP telephony service provider, one for each service plan, which may also be somewhat inconvenient.

In addition, when a user signs up for two separate service plans, and downloads and installs two separate software applications, the IP telephony service provider may not be aware that both service plans are being used by the same user. Particularly if the user provides different identity information for each account, whether by accident, or on purpose. Thus, it can be difficult for the IP telephony service provider to track the overall communication behavior of the user. This, in turn, can make it difficult for the IP telephony service provider to effectively market alternate or upgraded service plans to the user. Also, in many instances, the IP telephony service provider must prepare and send two separate monthly bills to the user, and track payment of the separate bills, instead of sending and tracking a single consolidated bill.

Further, when a user runs an IP telephony software application to obtain telephony services from an IP telephony service provider, the software application typically only provides the identification number associated with the software application as an identifier. The IP telephony service provider must then utilize the identifier associated with the software application to determine the service plan that is associated with the software application. The IP telephony service provider can then utilize information about the service plan to determine if the user is authorized to receive the requested telephony services, and if so, how much the user should be charged.

### BRIEF DESCRIPTION OF THE DRAWINGS

FIG. 1 is a diagram of a communications environment including various elements which are associated with an Internet protocol (IP) telephony system in accordance with an embodiment of the invention;

FIG. 2 is a diagram of various elements of a processor that forms part of an IP telephony system or an IP telephony device according to an embodiment of the invention;

FIG. 3 is block diagram illustrating various elements of an IP telephony system according to an embodiment of the invention;

FIG. 4 is a block diagram of various elements of an IP telephony device or an IP telephony software application which may be resident on a user's telephony device according to an embodiment of the invention;

FIG. 5 is a flowchart illustrating steps of a method that would be performed by a user's IP telephony device or an IP telephony software application to generate a new telephony communication setup request that includes information about a service plan that should be used for the new telephony communication;

FIG. 6 is a flowchart illustrating steps of a method of interacting with a user to obtain information from the user that is used to select a service plan to be used for a new telephony communication; and

FIG. 7 is a flowchart illustrating steps of a method of that would be performed by one or more elements of an IP telephony system to identify which service plan to use for a new telephony communication.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

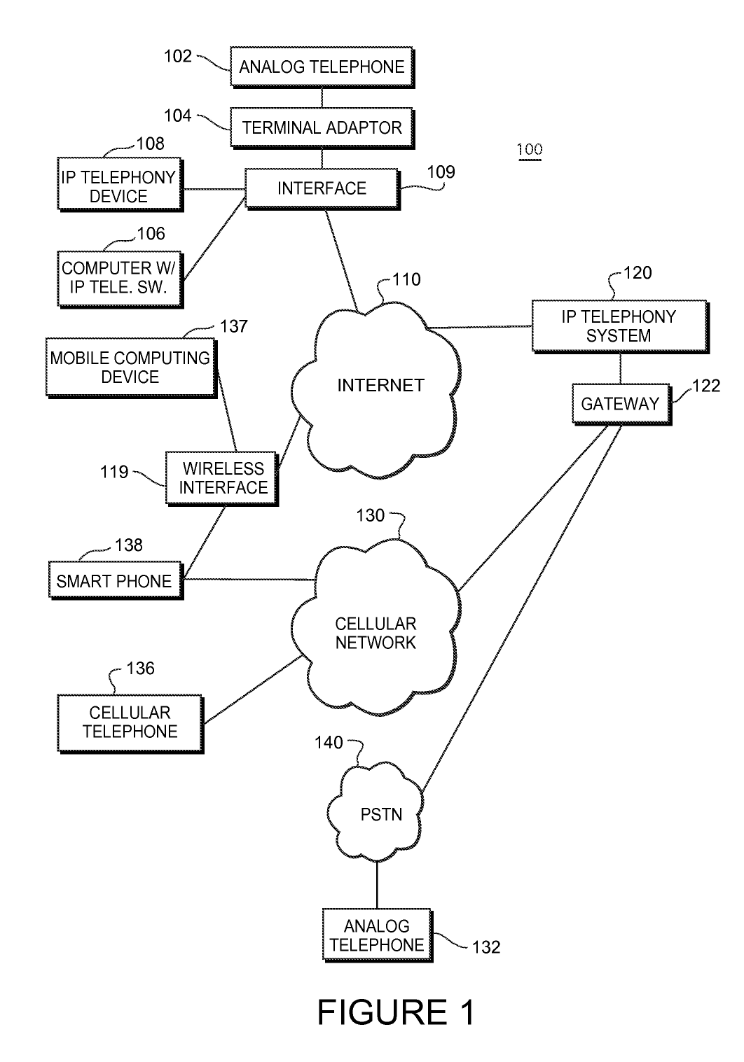

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to a publicly switched telephone network (PSTN) 140 and/or a cellular network 130 via one or more gateways 122.

The gateway 122 allows users and devices that are connected to the PSTN 140 or cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110 via a data network interface 109. The IP telephone 108 could be connected to the data network interface 109 via a wired or wireless connection.

Alternatively, a customer could utilize a normal analog telephone 102 which is connected to the Internet 110 via a terminal adapter 104 and the data network interface 109. The terminal adapter 104 converts analog signals from the telephone 102 into data signals that pass over the Internet 110, and vice versa. Analog telephony devices include, but are not limited to, standard telephones and document imaging devices such as facsimile machines. A configuration using a terminal adapter 104 is common where the analog telephone 102 is located in a residence or business

In addition, a customer could utilize a computer that is running IP telephony software 106 to place and receive IP based telephone calls, and to access other IP telephony systems (not shown). Here again, the computer running IP telephony software 106 would access the Internet 110 via the data network interface 109. In some instances, the IP telephony software could be assigned its own telephone number. In other instances, the IP telephony software could be associated with a telephone number that is also assigned to an IP telephone 108, or to a terminal adaptor 104 that is connected to an analog telephone 102.

In addition, a mobile computing device 137 which is running IP telephony software could also be used to place and receive telephone calls through the IP telephony system 120. The mobile computing device 137 accesses the Internet 110 via a wireless data network interface 119. The wireless data network interface could be a WiFi or WiMax router, or any other type of wireless data interface device capable of communicating wirelessly with the mobile computing device 137.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. A third party using a cellular telephone 136 could also place a call to an IP telephony system 120 customer, and the connection would be established in a similar manner, although the first link would involve communications between the cellular telephone 136 and a cellular telephone network 130.

A smart phone 138 which includes cellular telephone capabilities could also be used to conduct telephony communications through both the IP telephony system 120 and the cellular network 130. For example, an IP telephony software application running on the smart phone 138 could communicate with the IP telephony system 120 via the Internet 110. The smart phone 138 could access the Internet 110 via the wireless data network interface device 119, or via a data channel of the cellular network 130. Of course, alternate embodiments could utilize any other form of wired or wireless communications paths to enable communications.

Users of the IP telephony system 120 are able to access the service from virtually any location where they can connect to the Internet 110. Thus, a customer could register with an IP telephony system in the U.S., and that customer could then use an IP telephone 108 located in a country outside the U.S. to access the services. Likewise, the customer could also utilize a computer outside the U.S. that is running IP telephony software to access the IP telephony system 120. Further, in some instances a user could place a telephone call with the analog telephone 132 or the cellular telephone 136 that is routed through the PSTN 130 or cellular network 140 to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system 120 network. Thus, the user is able place a long distance call using lower cost IP telephony service provided by the IP telephony system 120, rather than a higher cost service provided by the PSTN 140 or cellular network 130.

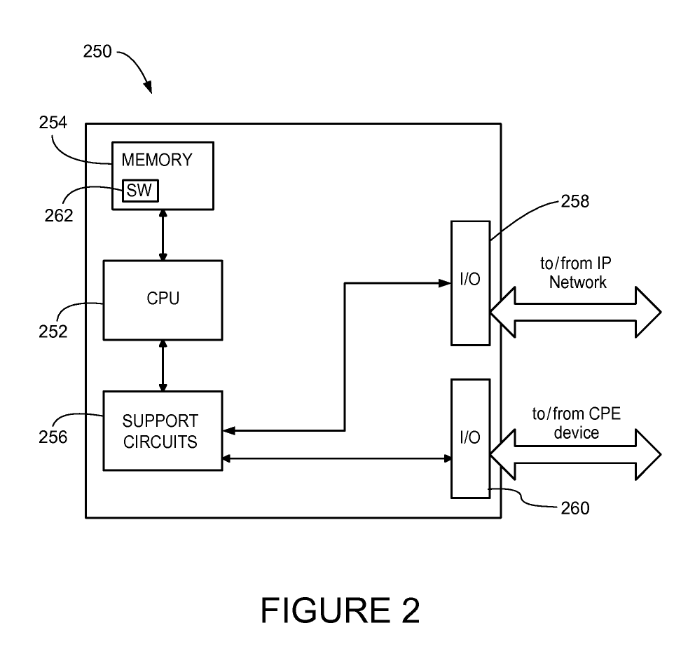

FIG. 2 illustrates elements of a computer processor 250 that can be used as part of the IP telephony system 120 or a telephony device to accomplish various functions. The IP telephony system 120 could include multiple processors 250 located at various locations in the system, along with their operating components and programming, each carrying out a specific or dedicated portion of the functions performed by the IP telephony system 120.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

References to an “IP telephony device” appear in both the foregoing and following descriptions. This term is used to refer to any type of device which is capable of interacting with an IP telephony system to conduct a communication. An IP telephony device could be an IP telephone, a computer running IP telephony software, a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

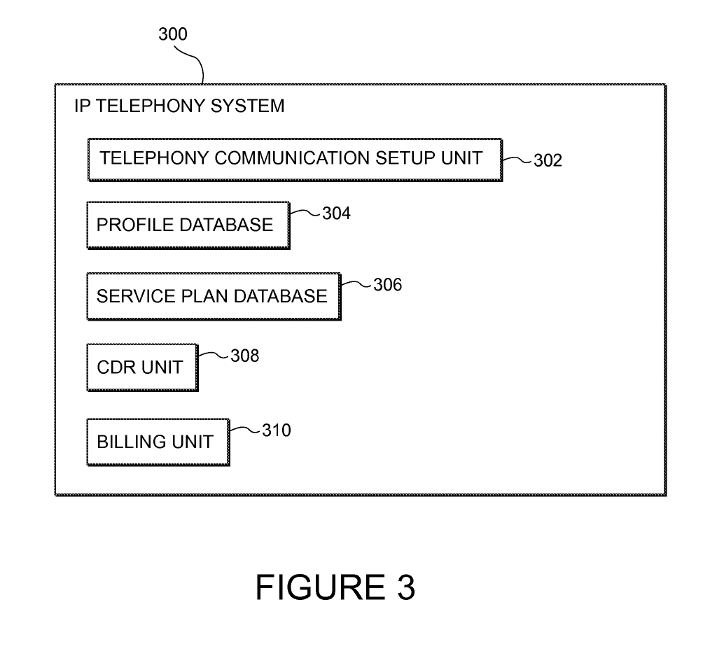

FIG. 3 illustrates selected elements of an IP telephony system 300 according to one embodiment of the invention. The IP telephony system 300 includes a telephony communication setup unit 302 which interacts with user telephony devices to setup requested telephony communications, such as telephone calls. A profile database 304 records information about users and the telephony devices that the users have and use to obtain telephony services. A service plan database 306 contains information about the service plans that each user has, and information about the service plans themselves. A call detail record (CDR) unit 308 generates call detail records for the telephony communications provided to users. A billing unit generates bills for the users based on information in the CDRs, and possibly based on information from other sources, such as the service plan database 304.

An IP telephony system 300 typically would include many other features which are not illustrated in FIG. 3. Also, some of the features illustrated in FIG. 3 may not be present in every embodiment. Thus, the depiction provided in FIG. 3 should in no way be considered limiting.

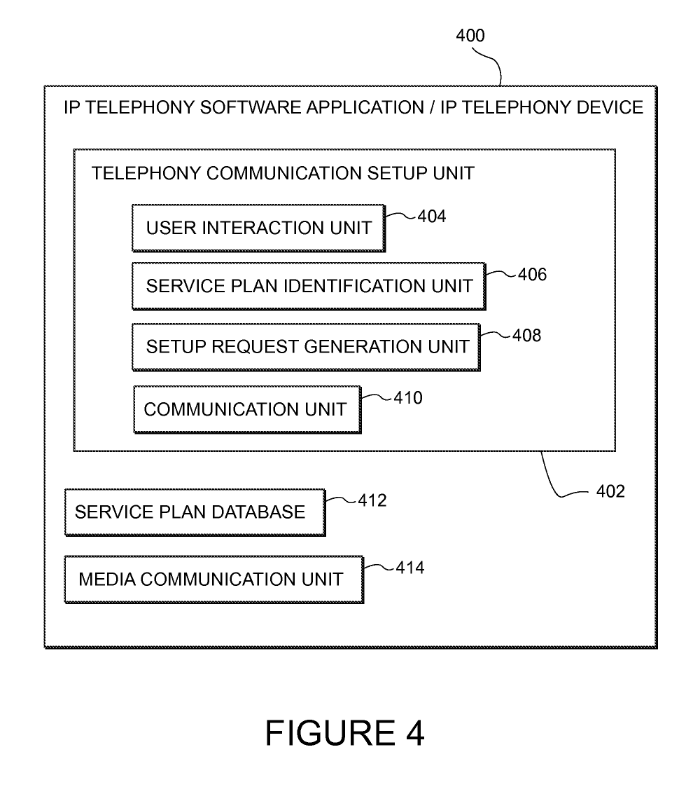

FIG. 4 illustrates selected elements of an IP telephony software application 400 that would be loaded onto a user's computing device or smart phone. Alternatively, the elements of FIG. 4 may be present in a user's IP telephony device. The elements include a telephony communication setup unit 402 which interacts with elements of an IP telephony system to setup telephony communications. The telephony communication setup unit 402 includes a user interaction unit 404 that interacts with a user to determine what telephony services the user desires, and possibly what service plan the user wishes to use to obtain those telephony services. A service plan identification unit 406 determines which of multiple service plans should be used to obtain telephony services requested by a user. The service plan identification unit 406 may operate independently to make that determination. Alternatively, the service plan identification unit 406 may interact with the user directly, or with the assistance of the user interaction unit 404, to help make the determination. A setup request generation unit 408 generates a new communication setup request that may include an indication about the service plan that a user wishes to use to conduct the new telephony communication. A communication unit 410 interacts with elements of the IP telephony system to help setup requested telephony communications.

The elements of the IP telephony software application 400 also include a service plan database 412 which includes information about one or more service plans that a user may have purchased or signed up for with an IP telephony system. Information in the service plan database 412 could include information about what services can be obtained under each service plan, the costs of obtaining services under each service plan, and information about an anticipated call quality that will be provided under certain service plans. If a service plan is a pre-paid service plan, information about the remaining amount of unused telephony services for the service plan may also be recorded in the service plan database 412. Of course, other types of information about the service plans may also be stored in the service plan database 412.

The IP telephony software application 400 also includes a media communication unit 414. After the telephony communication setup unit 402 establishes a new telephony communication for a user, the media communication unit 414 is responsible for exchanging data packets with elements of a data network to conduct the telephony communication.

When a user wishes to purchase or setup two or more service plans with a single IP telephony system, the user interacts with the IP telephony system to sign up for each plan, and to pre-pay for any service plans requiring pre-payment. This process may be accomplished using an IP telephony software application on the user's computer or smart phone, such as the one illustrated in FIG. 4. Alternatively, an IP telephony device may be configured to allow the user to perform these functions. In still other embodiments, the user may utilize a web-based interface provided by the IP telephony system to sign up for two or more service plans. In still other embodiments, a user might interact with a customer service agent, or an interactive voice response system, to sign up for one or more of multiple service plans. Of course, any other method of signing up for one or more service plans could also be used.

Regardless of the method used, the IP telephony system is ultimately provided with an identifier of an IP telephony device or an IP telephony software application that will be utilized to obtain services under two or more service plans. The identifier could be provided to the IP telephony system automatically by the IP telephony device or IP telephony software application. Alternatively, the user might obtain such an identifier and provide it to the IP telephony system.

As mentioned above, the IP telephony system 300 includes a service plan database 306 which includes information about the various service plans which each user has purchased or signed up for. The identifier of the user's IP telephony device or the identifier of an IP telephony software application that will be used to obtain services under each plan may be recorded in the service plan database 306. Alternatively, or in addition, the identifier of the user's IP telephony device or IP telephony software application may be recorded against the user's profile in a profile database 304.

In some instances, a user may make use of multiple IP telephony devices or multiple IP telephony software applications (loaded on the same or different computing devices) to obtain services under the same service plan. For example, a user may utilize both an IP telephony device present in the user's home or office, as well as an IP telephony software application on a user's smart phone to obtain telephony services under the same service plan. In that instance, identifiers associated with each of the multiple IP telephony devices and/or identifiers associated with one or more IP telephony software applications may be recorded against a single service plan listed in the service plan database 306 and/or against a single user entry in the profile database 304. Likewise, if the user has two service plans, those same identifiers associated with multiple IP telephony devices and/or identifiers associated with one or more IP telephony software applications may be recorded against a two service plans listed in the service plan database 306.

Similarly, when a user has purchased or signed up for multiple service plans, information identifying the multiple service plans may be recorded in a service plan database 412 that is present in an IP software application, or on an IP telephony device 400. The information in the service plan database 412 could be limited to just an identification of the types of service plans. However, in alternate embodiments, information about the service plans themselves could also be recorded in the service plan database 412.

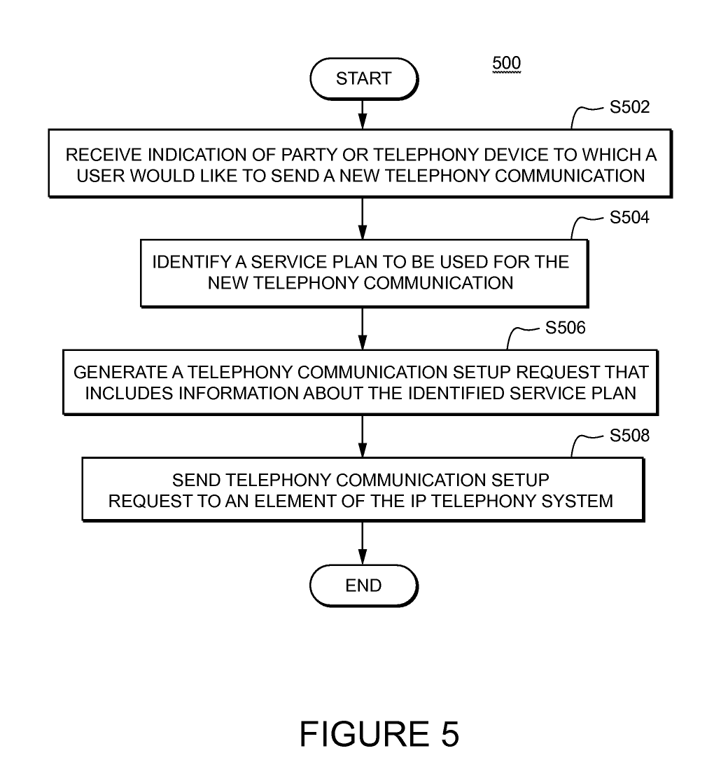

With the above-described background, various methods will now be discussed with references to FIGS. 5-7.

FIG. 5 illustrates steps of a method that would be performed by a user's IP telephony device or by an IP telephony software application to generate a telephony communication setup request for a new telephony communication. For purposes of the following description, we will assume that the user is making use of an IP telephony software application loaded and running on a computer, a smart phone or some other IP telephony device. However, the following description is equally applicable to a method where a user is making use of an IP telephony device.

The method 500 begins and proceeds to step S502, where a user interaction unit 404 of an IP telephony software application 400 receives information about a party or a telephony device to which a user would like to send or with which a user would like to setup a new telephony communication. This would typically involve a user selecting a party or entry on a contact list, or inputting a telephone number or some other identifier that can be used to contact another party. For example, step S502 could include a user selecting a name from a contact list or a call log. Alternatively, the user may speak a name of a party or a contact, and the IP telephony software application and/or the user's IP telephony device could interpret the spoken input and use the spoken input to make a selection from a contact list or a call log. In still other instances, a user could input all or a part of a name using a keypad, and that input could be used to look up the appropriate party on a contact list or call log. In yet other embodiments, a user could input a telephone number or some other identifier.

In step S504, the service plan identification unit 406 of the IP telephony software application 400 identifies a service plan that is to be used to setup the requested new telephony communication. If the user has only purchased or setup a single service plan, there is no choice to be made. However, where a user has purchased or setup multiple service plans, step S504 would include selecting one of the multiple service plans for use in setting up the new telephony communication.

In some embodiments, the service plan identification unit 406 may automatically choose the most appropriate service plan to be used. For example, if the user has setup a first service plan for domestic telephone calls, and a second service plan for telephone calls to other countries, then the service plan identification unit 406 determines whether the requested new telephony communication is directed to a domestic or foreign party, and then selects the appropriate service plan to be used.

In situations where two or more service plans could be used to setup a new requested telephony communication, the service plan identification unit 406 may be configured to automatically select a service plan based on certain criteria. For example, the service plan identification unit 406 could determine the cost of conducting the requested new telephony communication under each of multiple plans, and then automatically select the service plan that will minimize the user's costs. In yet other instances, the service plan identification unit 406 could review the projected call quality that is likely to be provided under each of multiple service plans, and then automatically select the service plan offering the best projected call quality. The user may be able to configure the service plan identification unit 406 to make these automatic selections in various different ways, and based on various different criteria. Also, combinations of factors could be used to make a service plan selection.

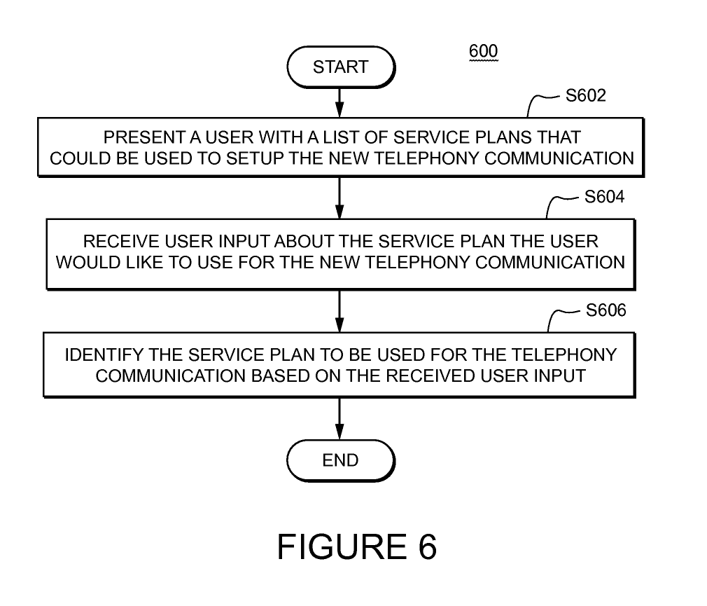

In still other embodiments, step S504 could involve interacting with a user to determine which service plan to use for a new telephony communication. Details of an exemplary method of interacting with a user to select a service plan are provided below with references to FIG. 6.

Once a service plan has been selected, the method proceeds to step S506, where a setup request generation unit 408 generates a telephony communication setup request that can be transmitted to an IP telephony system to request the new telephony communication. The telephony communication setup request includes information about the selected service plan that is to be used for the new telephony communication. This information could simply be an identifier that identifies a particular service plan. Alternatively other information could be provided that is used by the IP telephony system to identity the service plan that has been selected.

In some embodiments, the telephony communication setup request may be a Session Initiation Protocol (SIP) Invite message. In this instance, information about the identified service plan could be recorded in a header of the SIP Invite message that is not being used for other purposes. As will be explained below, this information can be reviewed by the IP telephony system to rapidly and easily determine what service plan to use for the new telephony communication.

In alternate embodiments, the new telephony communication setup request could take other forms. In that case, information about the selected service plan could be included in the setup request in other ways. Regardless, some item of information in the setup request will indicate which service plan the IP telephony system should use to setup the new telephony communication for the user.

In step S508, the communication unit 410 of the telephony communication setup unit 402 of the IP telephony software application 400 sends the telephony communication setup requested generated in step S506 to an element of an IP telephony system 300. The method then ends.

As mentioned above, step S504 could involve interacting with a user to identify a service plan to be used for the new telephony communication. FIG. 6 illustrates one method of interacting with a user to obtain information about the user's preferences for the service plan that is used.

The method 600 begins and proceeds to step S602, where a user interaction unit 404 of the IP telephony software application causes a list to be presented to the user, the list including the various service plans that could be used to setup the requested new telephony communication. As mentioned above, a user may only have a singe service plan capable of being used to setup the new telephony communication. However, where multiple service plans could be used, the multiple service plans are presented to the user in a list.

The list of service plans could be presented to the user in many different ways. In some embodiments, a display screen of the user's telephony device displays the service plan options. In other instances, the choices may be played to the user as audio output. Other ways of communicating the service plan options to the user could also be utilized.

If the user has purchased or signed up for multiple service plans, but some of the service plans cannot be used to conduct the requested telephony communication, all service plan options may be displayed, but those which cannot be used may be presented in a different fashion from those service plan options that can be used. This would make it clear to the user that although multiple service plans exist, some cannot be used for the requested telephony communication.

The information displayed to the user could include information beyond just a list of the service plans. For example, information about the relative costs of using each of the service plans to conduct the new telephony communication could also be presented. This could include the respective actual per-minute costs of conducting a telephone call under each of the service plans, or perhaps the relative costs of sending a SMS or MMS message under each of the service plans.

The information presented to the user might also include information about the projected call quality that will be provided by each of the respective service plans. Such call quality projections could be based on historical data that has been collected over time. The call quality information that is presented may be based on the identity or location of the called party. Also, because call quality can vary depending on the time-of-day or the day-of-the-week, the time of day and/or the day of the week may also be taken into account when presenting projected call quality information for each of the service plan options.

In step S604, the user interaction unit 404 receives input from the user that is indicative of the service plan option the user would like to select for purposes of conducting the new telephony communication. The user may provide this input in any suitable fashion. For example, if the user's telephony device includes a touch sensitive screen, the user could touch the portion of the screen displaying a desired service plan. Alternatively, the service plan options could be numbered, and the user could press a corresponding number key of a keypad to make a selection. A user might also be capable of speaking which option is to be selected, and the IP telephony software and/or the user's telephony device may interpret the spoken input.

In step S606, the user's input is interpreted, and the service plan selection is provided to the service plan identification unit 406. The method then ends.

The end result of the above-described methods is that IP telephony software application on a user's telephony device, or the telephony device itself, generates a new telephony communication setup request, and the setup request is communicated to an element of the IP telephony system. The setup request includes an indication of the service plan that is to be used to conduct the requested telephony communication.

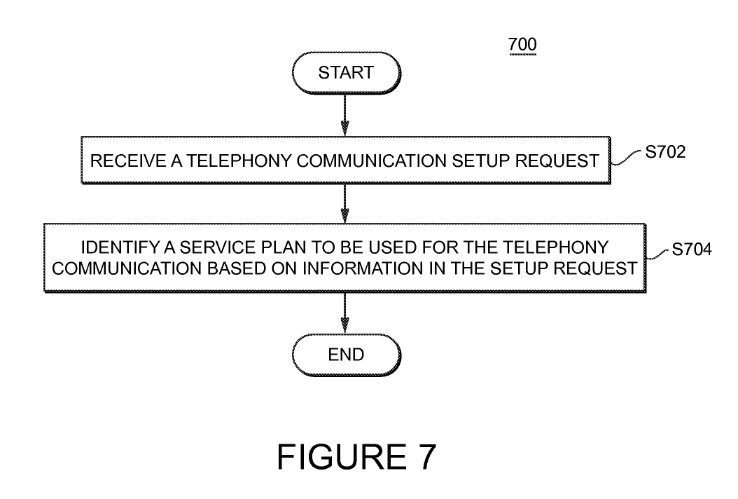

FIG. 7 illustrates steps of a method that would be performed by one or more elements of the IP telephony system 300 in receiving and interpreting a telephony communication setup request received from a user telephony device that is associated with a plurality of service plans. In some instances, the telephony communication setup request could include information identifying a specific service plan that is to be used to setup the requested telephony communication. In other instances, the setup request may not include any information about the service plan that is to be used.

The method 700 begins and proceeds to step S702, where a telephony communication setup unit 302 of an IP telephony system 300 receives the telephony communication setup request sent from a user telephony device or IP telephony software application that is associated with a plurality of service plans. In step S704, the telephony communication setup unit 302 utilizes information in the setup request to determine what service plan to use for the requested telephony communication. The way in which step S704 is performed can vary depending on the embodiment, and depending on the information that is contained in the setup request.

If the setup request includes information that identifies the service plan that should be used to setup the requested telephony communication, step S704 would simply involve reviewing and interpreting the information in the setup request to determine the service plan that should be used. For example, if the setup request is a SIP Invite message, step S704 could include reviewing information about a selected service plan that is recorded in a header of the SIP Invite message. This information could be in the form of a service plan identifier.

In some instances, the information present in the setup request may require some degree of interpretation. For example, it may be necessary for the telephony communication setup unit 302 to consult with a profile database 304 and/or a service plan database 306, using the information in the setup request, to determine the actual service plan that is to be used for the requested telephony communication. In other instances, all the information needed to identify the service plan that is to be used may be present in the setup request.

In other instances, the setup request may not include any information about the service plan that is to be used. In this case, other information is taken into account by the telephony communication setup unit 302 to determine the service plan that is to be used. For example, in some embodiments, the telephony communication setup unit 302 could determine the relative costs of conducting the requested telephony communication under each of the service plans that are associated with the user telephony device that sent the setup request. The service plan offering the lowest rates then could be selected. Information in the service plan database 306, and/or information from other sources could be used to make this determination.

In alternate embodiments, the telephony communication setup unit 302 could determine the projected communication quality that would be offered under each of the service plans that are associated with the user telephony device that sent the setup request. The service plan offering the best projected communication quality then could be selected. Information in the service plan database 306, and/or information from other sources could be used to make this determination. In still other embodiments, a mix of cost and projected communication quality information could be used to determine the service plan to use for the requested telephony communication.

In some embodiments, the identity of the party to which the telephony communication is directed could be taken into account in selecting the service plan that is to be used for the requested telephony communication. Information about the identity of the party to which the telephony communication is directed would be contained in the setup request, such as in the form of a dialed telephone number.

For example, when two service plans are associated with a user or a user telephony device, the respective service plan limitations or rules may be such that only one of the two plans can be used to conduct the requested telephony communication. If the telephony communication is directed to a party in a different country, only one of two service plans may allow telephony communications to that country. Under these circumstances, the service plan that is capable of being used for the requested telephony communication is selected. Here again, it may be necessary for the telephony communication setup unit 302 to consult with a profile database 304 and/or a service plan database 306 to determine whether individual service plans can be used to conduct the requested telephony communication.

In other instances, if two or more plans associated with a user or a user telephony device could be used to conduct the requested telephony communication, the identity of the party to which the telephony communication is directed could still be useful in determining which service plan to use. For example, the identity of the party to which the telephony communication is directed, and/or the location of that party, could have a significant affect on the cost of conducting the telephony communication under each of the service plans. Likewise, the identity or location of the party to which the telephony communication is directed could greatly affect the projected communication quality that would be provided under each of the service plans.

Once the service plan has been identified in step S704, the method will end. However, the telephony communication setup unit 302 will then proceed to attempt to setup the requested telephony communication for the user. In doing so, information about the service plan that is to be used may be encoded into communications sent to other elements of the IP telephony system 300. Information about the service plan that is to be used also may be communicated directly or indirectly to other elements of the IP telephony system 300, such as the CDR unit 308 or the billing unit 310.

The systems and methods described above have several advantages over known systems and methods. First, the systems and methods described above allow a single user telephony device or a single IP telephony software application to select one of multiple service plans to setup a new telephony communications. Thus, a user need not download, maintain and use separate IP telephony software applications for each of the service plans he may have purchased and/or signed up for.

Second, the user's telephony device or the IP telephony software application may be configured to automatically select the most appropriate service plan to be used for a new telephony communication based on cost, quality or other considerations. This relieves the user of figuring out which service plan is best. This also prevents the user from mistakenly using a service plan for a telephony communication that is less than ideal.

Also, the user's telephony device and/or IP telephony software application may be configured to interact with the user to allow the user to select the most appropriate service plan for a requested IP telephony communication. This can include presenting the user with information about the service plans that might otherwise be unavailable to the user, or which might be highly inconvenient to review in a quick, easy fashion.

Moreover, by encoding a selected service plan in the telephony communication setup request, the IP telephony system can quickly and easily determine which service plan to use for a new requested telephony communication. There is no need for an element of the IP telephony system to look up a user based on an identifier of a telephony device or an IP telephony software application to determine which service plan is associated with the identifier. The service plan information is readily available in the setup request itself.

The systems and methods described above also allow the IP telephony system to better determine which service plans are associated with a single user. This allows the IP telephony system to better track all the user's telephony communications activity. Tracking the overall communications activity of a user may allow the IP telephony system to better market new service plans to the user. Also, the ability to better track a single user's overall communications activity may make it possible for the IP telephony system to develop new service plan offerings that may better service the needs of their customers.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of generating a telephony communication setup request, comprising:
receiving information identifying a party or a telephony device to which a user would like to direct a new telephony communication;
identifying a service plan to use for the new telephony communication; and
generating a telephony communication setup request that includes information regarding the identified service plan.

2. The method of claim 1, wherein the generating step comprises generating a Session Initiation Protocol (SIP) Invite message that includes information regarding the identified service plan in a header of the Invite message.

3. The method of claim 1, wherein the generating step comprises generating a Session Initiation Protocol (SIP) Invite message that includes a service plan identifier in a header of the Invite message.

4. The method of claim 1, wherein the identifying step comprises identifying the service plan based on an identity or identifier associated with the party or telephony device to which the user would like to direct the new telephony communication.

5. The method of claim 1, wherein the identifying step comprises receiving input from the user as to which of multiple service plans the user would like to use for the new telephony communication.

6. The method of claim 1, wherein the identifying step comprises:
presenting the user with a list of service plans that could be used for the new telephony communication; and
receiving input from the user that is indicative of the service plan the user would like to use for the telephony communication.

7. The method of claim 6, wherein the presenting step comprises presenting the user with a list of service plans that also includes, for each service plan, information indicative of the estimated cost of using each of the service plans for the new telephony communication.

8. The method of claim 6, wherein the presenting step comprises presenting the user with a list of service plans that also includes, for each service plan, information indicative of a projected call quality that would be provided under each of the service plans for the new telephony communication.

9. The method of claim 8, wherein the list of service plans includes, for each service plan, information indicative of a call quality that is typically provided under each of the service plans for telephony communications directed to the location of the party or telephony device to which the user would like to direct the new telephony communication.

10. The method of claim 1, wherein the identifying step comprises:
obtaining information about the relative costs of using each of multiple service plans for the new telephony communication; and
identifying one of the multiple service plans as the service plan to be used for the new telephony communication based on the obtained cost information.

11. A system for generating a telephony communication setup request, comprising:
means for receiving information identifying a party or a telephony device to which a user would like to direct a new telephony communication;
means for identifying a service plan to use for the new telephony communication; and
means for generating a telephony communication setup request that includes information regarding the identified service plan.

12. A system for generating a telephony communication setup request, comprising:
a user interaction unit that receives information identifying a party or a telephony device to which a user would like to direct a new telephony communication;
a service plan identification unit that identifies a service plan to use for the new telephony communication; and
a setup request generation unit that generates a telephony communication setup request that includes information regarding the identified service plan.

13. The system of claim 12, wherein the setup request generation unit generates a Session Initiation Protocol (SIP) Invite message that includes information regarding the identified service plan in a header of the Invite message.

14. The system of claim 12, wherein the setup request generation unit generates a Session Initiation Protocol (SIP) Invite message that includes a service plan identifier in a header of the Invite message.

15. The system of claim 12, wherein the service plan identification unit identifies the service plan based on an identity or identifier associated with the party or telephony device to which the user would like to direct the new telephony communication.

16. The system of claim 12, wherein the service plan identification unit receives input from the user as to which of multiple service plans the user would like to use for the new telephony communication.

17. The system of claim 12, wherein the service plan identification unit presents the user with a list of service plans that could be used for the new telephony communication, and receives input from the user that is indicative of the service plan the user would like to use for the telephony communication.

18. The system of claim 17, wherein the service plan identification unit presents the user with a list of service plans that also includes, for each service plan, information indicative of the estimated cost of using each of the service plans for the new telephony communication.

19. The system of claim 17, wherein the service plan identification unit presents the user with a list of service plans that also includes, for each service plan, information indicative of a projected call quality that would be provided under each of the service plans for the new telephony communication.

20. The system of claim 19, wherein the service plan identification unit presents the user with a list of service plans that includes, for each service plan, information indicative of a call quality that is typically provided under each of the service plans for telephony communications directed to the location of the party or telephony device to which the user would like to direct the new telephony communication.

21. The system of claim 12, wherein the service plan identification unit obtains information about the relative costs of using each of multiple service plans for the new telephony communication, and identifies one of the multiple service plans as the service plan to be used for the new telephony communication based on the obtained cost information.
